(19) United States
(12) Patent Application Publication
(10) Pub. No.: US 2013/0070364 A1
(43) Pub. Date: Mar. 21, 2013

(54) THIN FILM MAGNETIC HEAD AND MANUFACTURING METHOD THEREOF

(71) Applicants: Yuji Matsuura, Tokyo (JP); Atsushi Yamaguchi, Tokyo (JP); Tetsuji Hori, Tokyo (JP); Naoto Matono, Hong Kong (HK)

(72) Inventors: Yuji Matsuura, Tokyo (JP); Atsushi Yamaguchi, Tokyo (JP); Tetsuji Hori, Tokyo (JP); Naoto Matono, Hong Kong (HK)

(73) Assignees: SAE Magnetics (H.K.) Ltd., Shatin (HK); TDK CORPORATION, Tokyo (JP)

(21) Appl. No.: 13/233,092

(22) Filed: Sep. 15, 2011

(51) Int. Cl. G11B 5/17; G11B 21/02; G11B 5/127; G11B 5/48

(52) U.S. Cl. 360/75; 360/123.03; 360/244; 29/603.07; G9B/5.05; G9B/5.147

(57) ABSTRACT

A thin film magnetic head of the present invention is configured to include a main pole layer; a main pole direct junction magnetic layer that has an auxiliary pole layer and an auxiliary yoke layer, the main pole direct junction magnetic layer being directly joined to the main pole layer in a state where a recording gap layer is partially intervened near an air bearing surface (ABS) with respect to the main pole layer; and a first magnetic recording exciting coil that is buried between the auxiliary pole layer and the auxiliary yoke layer configuring the main magnetic direct junction magnetic layer with an insulating layer therebetween. Thereby, an effective magnetic path length can be shortened in order to improve the high-frequency characteristics, and furthermore, simplification of the manufacturing processes becomes possible.

### BACKGROUND OF THE INVENTION

1. Field of the Invention

The present invention relates to a thin film magnetic head that performs the operation of magnetic recording in a perpendicular magnetic recording system and a manufacturing method thereof as well as a head gimbal assembly and a magnetic recording device.

2. Description of the Related Art

In recent years, there have been demands to improve performance in a thin film magnetic head and a magnetic recording medium respectively in conjunction with high recording density in magnetic recording and reproducing devices such as a magnetic recording device and the like.

Thin film magnetic heads can be broadly categorized according to the recording system, the so-called longitudinal magnetic recording system and perpendicular magnetic recording system. The longitudinal magnetic recording system is a system for recording data in a longitudinal direction that follows in the recording plane of the hard disc that is the magnetic recording medium. In contrast, the perpendicular magnetic recording system is a system for recording data by orienting a recording magnetization formed on the hard disc in a perpendicular direction to the recording plane.

Of these, the thin film magnetic head of the perpendicular magnetic recording system can realize a significantly higher recording density compared to the longitudinal magnetic recording system, and also the reliability of data is extremely high when in a high recording density state because the hard disc is not susceptible to the effects of heat fluctuation after recording information.

Thin film magnetic heads with a perpendicular magnetic recording system which is extremely advantageous in high recording density in this manner are the mainstream; however, the improvement of high-frequency characteristics of the thin film magnetic head of the perpendicular magnetic recording system has been sought in conjunction with further high recording density.

The reduction of the magnetic path length can be given as an improvement in high-frequency characteristics. However, the magnetic path length of the thin film magnetic head provided with a common configuration is generally substantially determined according to the number of turns of an exciting coil that is formed to generate a recording magnetic field toward the magnetic recording medium from the main pole. Therefore, significant shortening of the magnetic path length cannot be expected if the number of turns of the exciting coils is the same.

By focusing on such problems, US2009/0296275 discloses a thin film magnetic head with a perpendicular magnetic recording system aimed at shortening the magnetic path length by configuring the exciting coil in two steps.

However, the thin film magnetic head disclosed in US2009/0296275 adopts a structure where an integrated magnetic layer is formed with a main pole layer 26, an upper yoke layer 67 and an opposing shield layer 61. In the upper yoke layer 67, a gap layer 27 is partially intervened on the air bearing surface against the main pole layer 26 and insulating layers 31, 32, and 33 are included on the main pole layer 26. In the structure, an upper magnetic layer is further formed on this integrated magnetic layer, an exciting coil is buried in the magnetic layers 65 and 65 that are the upper magnetic layers.

Accordingly, although the appearance of the magnetic path length determined by a straight distance LM from the so-called air bearing surface to the exciting coil seems shorter, the distance in the lamination direction is longer, so the effective magnetic path length that is the total length of the magnetic path that is the actual path of the magnetic flux is not any shorter. In other words, the effective magnetic path length disclosed in US2009/0296275 is the total length that passes through the main pole layer 26, the upper yoke part 67, the first rear side shield part 65, the second rear side shield part 66, the connecting shield part 64, the second front side shield part 63, the first front side shield part 62, and the opposing shield part 61.

Further, the thin film magnetic head disclosed in the US2009/0296275 has a structure where photoresist layers 55 and 15 that are an organic material with a larger thermal expansion coefficient than a periphery material are filled respectively between the coils 52c and 52e and between the coils 11c and 11e. As a result, when the photoresist layers 55 and 15 largely expand due to the heat generated by applying a current to the coils or the like, the photoresist layers 55 and 15 partially push out an ABS end part that is the medium opposing surface of the write shield layer, and so there may be a risk in which this protruding portion contacts the opposing magnetic recording medium.

Further, the thin film magnetic head disclosed in US2009/0296275 includes many planarization processes and the like and has many numbers of steps in the process, so there is inconvenience in increasing the manufacturing costs.

The present invention is invented in such actual conditions, and an object thereof is to provide a thin film magnetic head with a structure in which the effective magnetic path length can be shortened in order to improve high-frequency characteristics, further, the thin film magnetic head with a structure less likely to cause a protruding portion by being partially pushed out in the ABS end part that is the medium opposing surface due to the heat generation by current applied to a coil or the like, and furthermore, the thin film magnetic head that can enhance simplifying of the manufacturing process as well as the manufacturing method thereof.

### SUMMARY OF THE INVENTION

In order to achieve the above objects, a thin film magnetic head of the present invention is configured to include a main pole layer, a main pole direct junction magnetic layer that has an auxiliary pole layer and an auxiliary yoke layer, the main pole direct junction magnetic layer being directly joined to the main pole layer in a state where a recording gap layer is partially intervened near an air bearing surface (ABS) with respect to the main pole layer; and a first magnetic recording exciting coil that is buried between the auxiliary pole layer and the auxiliary yoke layer configuring the main magnetic direct junction magnetic layer with an insulating layer therebetween.

Further, in a preferred embodiment of the thin film magnetic head of the present invention, a second magnetic recording exciting coil is formed on the first magnetic recording exciting coil with an insulating layer therebetween.

Further, in a preferred embodiment of the thin film magnetic head of the present invention, t2 is larger than t1 where the thickness of the lamination direction of the first magnetic recording exciting coil is t1 and the thickness of the lamination direction of the second magnetic recording exciting coil is t2, and at the same time, a number of turns of the second magnetic recording exciting coil is larger than a number of turns of the first magnetic recording exciting coil.

Further, in a preferred embodiment of the thin film magnetic head of the present invention, the second magnetic recording exciting coil has a plurality of turns and an insulating layer, which is a dry film, is buried in a wound coil gap.

Further, in a preferred embodiment of the thin film magnetic head of the present invention, the insulating layer of the dry film is an alumina film that is formed by an atomic layer deposition method with an insulating material.

Further, in a preferred embodiment of the thin film magnetic head of the present invention, X2≠X1 when the X2 and X1 are compared, where a distance X1 is defined from the front part of the first magnetic recording exciting coil to the ABS and a distance X2 is defined from the front part of the second magnetic recording exciting coil to the ABS.

Further, a head gimbal assembly of the present invention includes a slider that includes the thin film magnetic head that is described above and that is arranged so as to oppose a magnetic recording medium, and a suspension to elastically support the slider.

Further, a magnetic recording device of the present invention includes a slider that includes the thin film magnetic head that is described above and that is arranged so as to oppose a magnetic recording medium, and a positioning device that positions the slider with respect to the magnetic recording medium as well as supports the slider.

A manufacturing method of the thin film magnetic head of the present invention includes a process to form an auxiliary pole layer and an auxiliary yoke layer directly on a main pole layer in a state where a recording gap layer is partially intervened near an air bearing surface (ABS) after forming the main pole layer, a first magnetic recording exciting coil forming process that includes a process to bury a part of a first magnetic recording exciting coil in a gap of the auxiliary pole layer and the auxiliary yoke layer with an insulating layer therebetween, and a second magnetic recording exciting coil forming process to form the second magnetic recording exciting coil while connecting to the first magnetic recording exciting coil.

The manufacturing method of the thin film magnetic head of the present invention further includes an insulating layer forming process to enhance insulation with respect to the second magnetic recording exciting coil, an exposure process of the auxiliary pole layer and the auxiliary yoke layer to form a contact part by exposing the auxiliary pole layer and the auxiliary yoke layer; and a write shield layer forming process to form a write shield layer on the exposed auxiliary pole layer and the auxiliary yoke layer.

### BRIEF DESCRIPTION OF THE DRAWINGS

FIG. 1 is a perspective view illustrating schematically a magnetic recording device in one embodiment of the present invention.

FIG. 2 is a perspective view illustrating schematically a head gimbal assembly (HGA) in one embodiment of the present invention.

FIG. 3A is a cross-sectional view along the direction to intersect the ABS that is the medium opposing surface of a thin film magnetic head that relates to an example of a preferred embodiment of the present invention, and is a cross-sectional view of the line A-A of FIG. 3B. FIG. 3B is a front view illustrating the ABS that is the medium opposing surface of the thin film magnetic head.

FIG. 4A is a cross-sectional view along the direction to intersect the ABS illustrating an example of a manufacturing process of the thin film magnetic head that relates to an example of a preferred embodiment of the present invention. FIG. 4B is a plan view of FIG. 4A. In addition, the reduction in scale of both drawings is not depicted correspondently due to space restrictions on the surface of the paper, and FIG. 4B is in an exceedingly-reduced state.

FIG. 5A is a cross-sectional view along the direction to intersect the ABS illustrating an example of a manufacturing process of the thin film magnetic head that relates to an example of a preferred embodiment of the present invention. FIG. 5B is a plan view of FIG. 5A. In addition, the reduction in scale of both drawings is not depicted correspondently due to space restrictions on the surface of the paper, and FIG. 5B is in an exceedingly-reduced state.

FIG. 6A is a cross-sectional view along the direction to intersect the ABS illustrating an example of a manufacturing process of the thin film magnetic head that relates to an example of a preferred embodiment of the present invention. FIG. 6B is a plan view of FIG. 6A. In addition, the reduction in scale of both drawings is not depicted correspondently due to space restrictions on the surface of the paper, and FIG. 6B is in an exceedingly-reduced state.

FIG. 7A is a cross-sectional view along the direction to intersect the ABS illustrating an example of a manufacturing process of the thin film magnetic head that relates to an example of a preferred embodiment of the present invention. FIG. 7B is a plan view of FIG. 7A. In addition, the reduction in scale of both drawings is not depicted correspondently due to space restrictions on the surface of the paper, and FIG. 7B is in an exceedingly-reduced state.

FIG. 8A is a cross-sectional view along the direction to intersect the ABS illustrating an example of a manufacturing process of the thin film magnetic head that relates to an example of a preferred embodiment of the present invention. FIG. 8B is a plan view of FIG. 8A. In addition, the reduction in scale of both drawings is not depicted correspondently due to space restrictions on the surface of the paper, and FIG. 8B is in an exceedingly-reduced state.

FIG. 9A is a cross-sectional view along the direction to intersect the ABS illustrating an example of a manufacturing process of the thin film magnetic head that relates to an example of a preferred embodiment of the present invention. FIG. 9B is a plan view of FIG. 9A. In addition, the reduction in scale of both drawings is not depicted correspondently due to space restrictions on the surface of the paper, and FIG. 9B is in an exceedingly-reduced state.

FIG. 10A is a cross-sectional view along the direction to intersect the ABS illustrating an example of a manufacturing process of the thin film magnetic head that relates to an example of a preferred embodiment of the present invention. FIG. 10B is a plan view of FIG. 10A. In addition, the reduction in scale of both drawings is not depicted correspondently due to space restrictions on the surface of the paper, and FIG. 10B is in an exceedingly-reduced state.

FIG. 11A is a cross-sectional view along the direction to intersect the ABS illustrating an example of a manufacturing process of the thin film magnetic head that relates to an example of a preferred embodiment of the present invention. FIG. 11B is a plan view of FIG. 11A. In addition, the reduction in scale of both drawings is not depicted correspondently due to space restrictions on the surface of the paper, and FIG. 11B is in an exceedingly-reduced state.

FIG. 12A is a cross-sectional view along the direction to intersect the ABS illustrating an example of a manufacturing process of the thin film magnetic head that relates to an example of a preferred embodiment of the present invention. FIG. 12B is a plan view of FIG. 12A. In addition, the reduction in scale of both drawings is not depicted correspondently due to space restrictions on the surface of the paper, and FIG. 12B is in an exceedingly-reduced state.

FIG. 13A is a cross-sectional view along the direction to intersect the ABS illustrating an example of a manufacturing process of the thin film magnetic head that relates to an example of a preferred embodiment of the present invention. FIG. 13B is a plan view of FIG. 13A. In addition, the reduction in scale of both drawings is not depicted correspondently due to space restrictions on the surface of the paper, ion and FIG. 13B is in an exceedingly-reduced state.

### DETAILED DESCRIPTION OF THE INVENTION

Hereinafter, a detail description is given regarding preferred embodiments for executing the present invention.

Prior to explaining preferred embodiments of the present invention, terminologies used in the present specification are defined. In a lamination structure or an element structure formed on an element formation surface of a slider substrate of a thin film magnetic head, a substrate side is referred to as “lower (under)” and its opposite side is referred to as “upper (above and on)” from a perspective of a layer or an element that is the standard. Also, a lamination direction corresponding to a lamination order of film formation is referred to as upper direction. Also, in embodiments of the thin film magnetic head, “X, Y and Z directions” are defined in some of the drawings as necessary. Here, the Z-axis direction corresponds to the above-described upper and lower direction, the +Z side corresponds to a trailing side, and the −Z side corresponds to a leading side. The Y-axis direction is referred to as a track width direction, and the X-axis direction is referred to as a height direction, a depth direction or rearward. Moreover, some of the drawings are illustrated changing their scale in the upper and lower directions and the left and right directions of configuration members to illustrate the configuration member visibly so that the scale may be different from an actual scale.

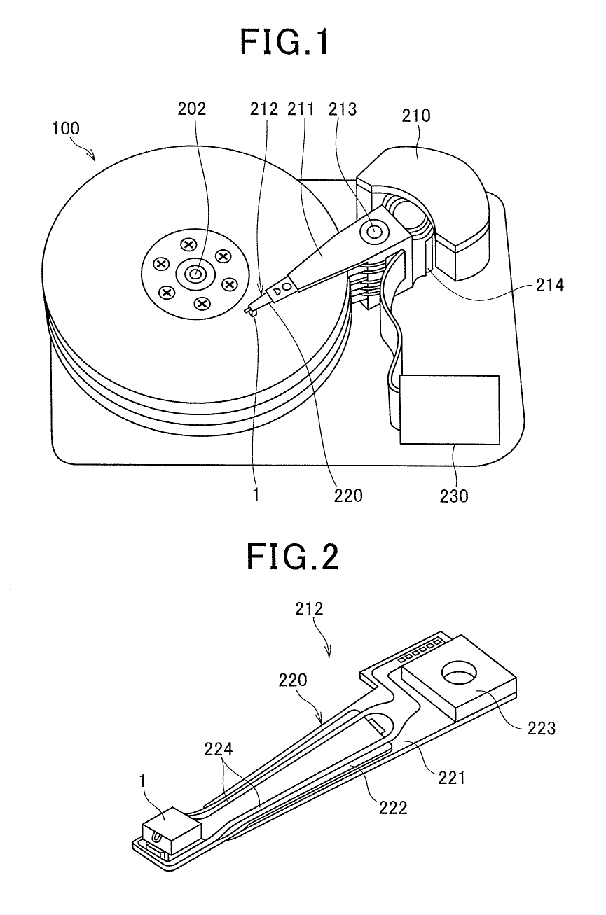

Prior to explaining the thin film magnetic head of the present invention in detail, a description is given regarding a magnetic recording device and a head gimbal assembly (HGA) including the thin film magnetic head with reference to FIG. 1-FIG. 2.

### Description Regarding Magnetic Recording Device and Head Gimbal Assembly (HGA)

FIG. 1 is a perspective view schematically illustrating a magnetic recording device mounting a thin film magnetic head of a present embodiment. FIG. 2 is a perspective view schematically illustrating a head gimbal assembly (HGA) provided with the thin film magnetic head of the present embodiment.

As illustrated in FIG. 1, the magnetic recording device according to the present embodiment is configured with a plurality of magnetic disks 100, an assembly carriage device 210, head gimbal assemblies (HGA) 212 and a control circuit 230. The magnetic disks 100 rotate around a rotational shaft of a spindle motor 202. The assembly carriage device 210 is provided with a plurality of drive arms 211. The HGAs 212 each is attached to a tip portion of each of the drive arms 211 and has the thin film magnetic head 1. The control circuit 230 controls writing and reading operations of the thin film magnetic head 1 according to the present embodiment.

In the present embodiment, the magnetic disks 100, which are magnetic recording media, are for perpendicular magnetic recording and each has a configuration in which, for example, a soft magnetic under layer, an intermediate layer and a magnetic recording layer (perpendicularly magnetized layer) or the like are sequentially laminated above a disk substrate.

The assembly carriage device 210 is a device for positioning the thin film magnetic heads 1 on tracks, which are formed on the magnetic disks 100 and on which recording bits are arrayed. In the assembly carriage device 210, the drive arms 211 are stacked in a direction along a pivot bearing shaft 213 and are angularly swingable by a voice coil motor (VCM) 214 centering around the pivot bearing shaft 213.

Note, the structure of the magnetic recording device of the present embodiment is not limited to the above-described structure but may include only a singular of the magnetic disk 100, the drive arm 211, the HGA 212 and the magnetic recording head 1.

In the HGA 212 illustrated in FIG. 2, a suspension 220 includes a load beam 221, a flexure 222 that is firmly attached to the load beam 221 and has elasticity, and a base plate 223 provided at a base of the load beam 221. In addition, a wiring member 224 formed from a lead conductor and connection pads electrically connected to both sides of the lead conductor is provided on the flexure 222. The magnetic recording head 1 according to the present embodiment is firmly attached to the flexure 222 at a tip end portion of the suspension 220 so as to oppose a surface of each of the magnetic disks 100 with a predetermined gap (flying height).

Further, one end of the wiring member 224 is electrically connected to a terminal electrode of the thin film magnetic head 1 according to the present embodiment. Note, the structure of the suspension 220 in the present embodiment is not limited to the above-described structure.

### Description of Configuration Example of Thin Film Magnetic Head

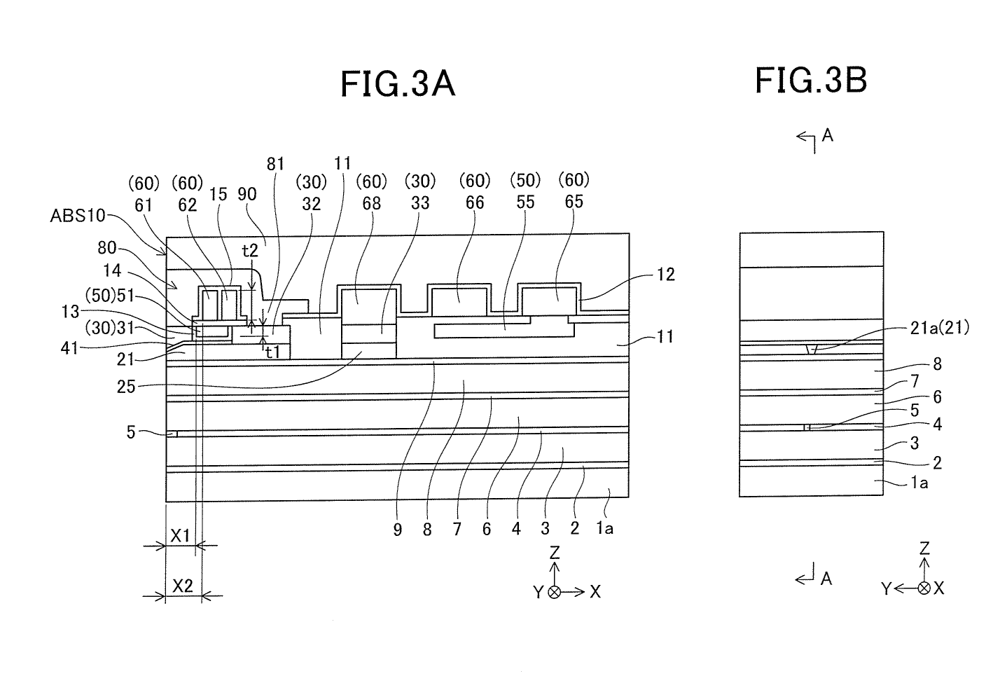

A description will be given of a configuration example of a preferred thin film magnetic head of a perpendicular magnetic recording system with reference to drawings FIG. 3A and FIG. 3B and FIG. 4A and FIG. 13B.

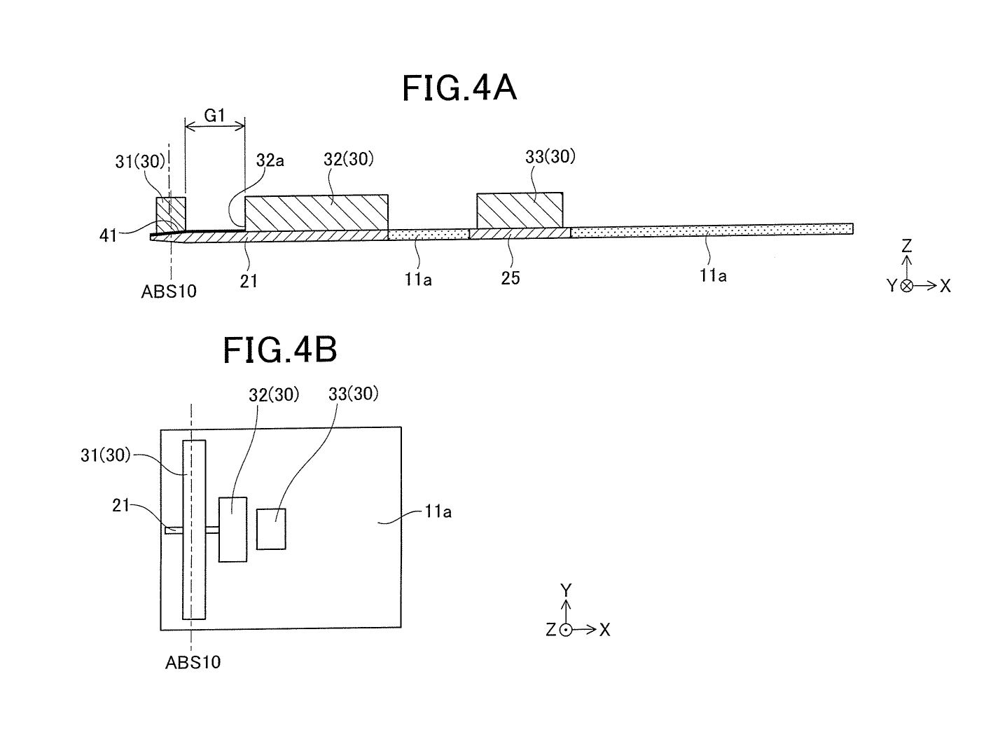

FIG. 3A is a cross-sectional view along the direction to intersect the ABS that is the medium opposing surface of a thin film magnetic head that relates to an example of a preferred embodiment of the present invention, and is a cross-sectional view of the line A-A of FIG. 3B. FIG. 3B is a front view illustrating the ABS that is the medium opposing surface of the thin film magnetic head. Each of the drawings from FIG. 4A to FIG. 13B is a drawing sequentially illustrating a manufacturing process of a preferred thin film magnetic head, and the A and B drawings of these indicate a cross-sectional view and a plan view respectively.

The thin film magnetic head 1 has a substrate 1a and a recording head and reproducing head that are laminated on the substrate 1a as illustrated in FIG. 3A and FIG. 3B. Further, the thin film magnetic head 1 has an ABS 10 (at times referred to hereinafter as the medium opposing surface 10) that is the medium opposing surface that opposes the magnetic recording medium. In FIG. 3A and FIG. 3B, the structure of the essential parts of the thin film magnetic head is depicted in the center. An understanding of the invention will be further clarified by referring to the manufacturing processes from FIG. 4A through FIG. 13B for the detailed structure of the essential parts of the invention.

The reproducing head has an MR element 5 arranged near the ABS 10 to detect a signal magnetic field from the magnetic recording medium. Further, the reproducing head has an insulating layer 2 formed on the substrate 1a, lower part shield layer 3 composed of a magnetic material, and a shield gap layer 4 that shields the side part, rear part, and the like of the MR element 5.

Furthermore, the reproducing head has an upper part shield layer 6 composed of a magnetic material that is formed on the shield gap layer 4, an insulating layer 7 formed on the upper part shield layer 6, and an intermediate shield layer 8 composed of a magnetic material that is formed on the insulating layer 7.

The lower part shield layer 3 and the upper part shield layer 6 are mainly provided to prevent the MR element 5 from receiving the external magnetic field that is to be noise. The intermediate shield layer 8 has a primary function to shield the MR element 5 from the magnetic field generated by the recording head; however, this layer 8 may be omitted without providing in particularly.

The lower part shield layer 3 and the upper part shield layer 6 together with the intermediate shield layer 8 are magnetic layers composed of a magnetic material formed by, for example, a frame plating method, a sputtering method, or the like, and are composed of for example, NiFe (permalloy), FeSiAl (Sendust), CoFeNi, CoFe, FeN, FeZrN, CoZrTaCr, or the like, or a soft magnetic material of a multilayer film of these materials or the like, and the thickness is, for example, anywhere approximately between 0.5-3 μm.

The MR element 5 is a magnetically sensitive part to sense a signal magnetic field by utilizing an MR effect, and may be any of, for example, a current in plane-giant magnetoresistive (CIP-GMR) multilayer body by utilizing the current in plane-giant magnetoresistive effect, a current perpendicular to plane-giant magnetoresistive (CPP-GMR) multilayer body by utilizing the current perpendicular to plane-giant magnetoresistive effect, or a tunnel-magnetoresistive (TMR) multilayer body by utilizing a tunnel-magnetoresistive effect.

The MR element 5 in which these MR effects are used can sense a signal magnetic field from the magnetic disc with high sensitivity. In addition, when the MR element 5 is a CPP-GMR multilayer body or a TMR multilayer body, the lower part shield layer 3 and the upper part shield layer 6 can also function as an electrode. In contrast, when the MR element 5 is a CIP-GMR multilayer body, insulating layers are provided respectively between the MR element 5 and the lower part shield layer 3 as well as the upper part shield layer 6, and an MR read layer that is electrically connected to the MR element 5 is also provided.

In the present embodiment, an insulating layer 9 is provided on the intermediate shield layer 8 and the recording head is formed on the insulating layer 9.

The recording head is for perpendicular magnetic recording, and is configured to include a main pole layer 21, a rear part magnetic layer 25, a recording gap layer 41, an auxiliary pole layer 31, an auxiliary yoke layer 32, a pillar 33, a write shield 80, a first magnetic recording exciting coil 50 (51 and 55), and a second magnetic recording exciting coil write coil layer 60 (61, 62, 65, 66, and 67).

The main pole layer 21 and the rear part magnetic layer 25 are formed on the insulating layer 9 composed of an insulating material, for example, Al₂O₃ (alumina) or the like. The main pole layer 21 configures a magnetic guide path to guide while converging a magnetic flux that is generated by applying write currents to the first magnetic recording exciting coil 50 (51 and 55) and the second magnetic recording exciting coil write coil layer 60 (61, 62, 65, 66, and 67), to the magnetic recording layer (perpendicular magnetized layer) of the magnetic disc where writing occurs.

In the ABS 10 that is the medium opposing surface, the main pole layer 21 has, for example, an end surface 21a of a so-called inverted trapezoidal shape where the upper side (+Z side) is wider than the lower side and the width is narrower as it approaches the lower direction as shown in FIG. 3B.

Further, although there is no illustration, it is preferred that the main pole layer 21 has a configuration that includes a main pole part having a small width in the track width direction and a main pole main body part with a wide width that is placed in the rear part direction (+X side) linked with the main pole part near the ABS 10 that is the medium opposing surface. As a result of the main pole part having a small width, a minute write magnetic field can be generated and the track width can be set to a micro value that corresponds to a high recording density.

The main pole part and the main pole main body part are formed of a soft magnetic material having a high saturation magnetic flux density and are formed of a soft magnetic material, for example, an iron-based alloy material in which Fe is the main component such as FeNi, FeCo, FeCoNi, FeN, FeZrN, or the like. Further, the main pole part and the main pole main body part may be respectively configured, as different bodies, of different soft magnetic materials. For example, the main pole part may be formed of a soft magnetic material having a higher saturation magnetic flux density than the main pole main body part.

The recording gap layer 41 is formed to form a gap in order to electrically separate the main pole layer 21 and the auxiliary pole layer 31 connected to the write shield 80, near the head end surface (ABS 10).

The recording gap layer 41 is configured with a non-magnetic insulating material, for example Al₂O₃ (alumina), SiO₂ (silicon dioxide), AlN (aluminum nitride), or a diamond-like carbon (DLC), or the like, or a non-magnetic conductive material such as Ru (ruthenium) or the like. The thickness of the recording gap layer 41 defines the gap between the main pole layer 21 and the auxiliary pole layer 31, and it is, for example, anywhere approximately between 0.01-0.5 μm.

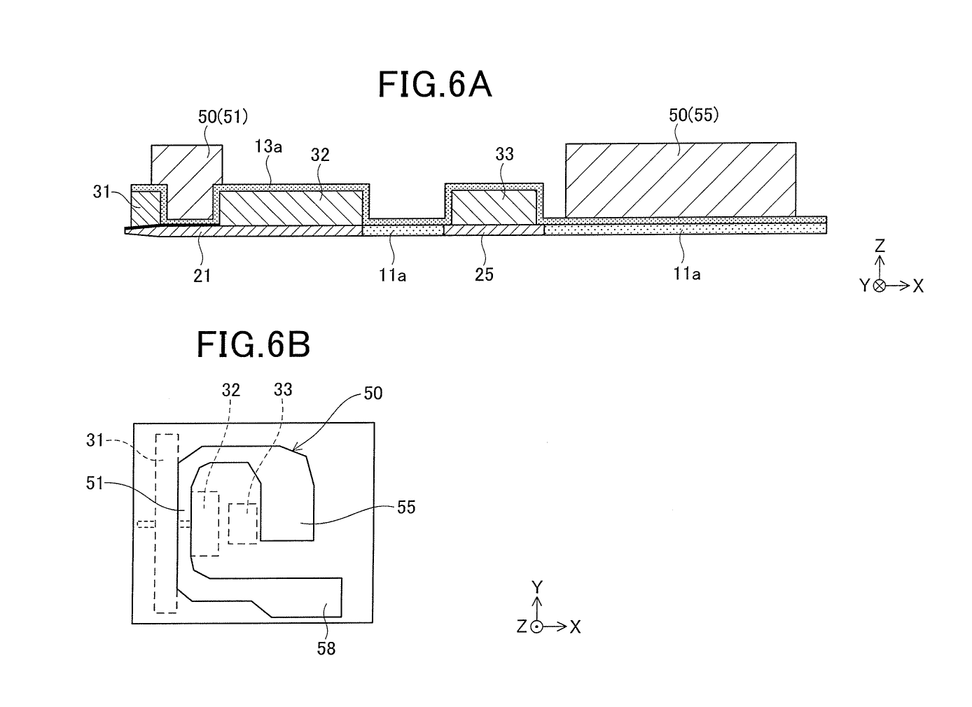

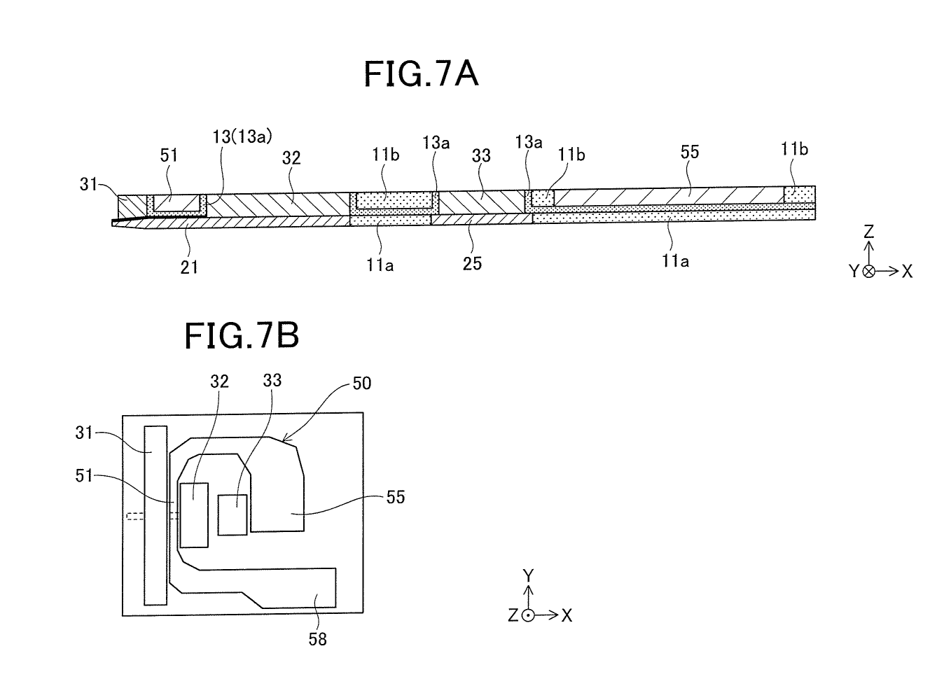

In the present invention, the main pole layer 21 and a main pole direct junction magnetic layer 30 provided with the auxiliary pole layer 31 and auxiliary yoke layer 32 are directly joined in a state where the recording gap layer 41 is partially intervened near the ABS 10 with respect to the main pole layer 21 as illustrated FIG. 3A. Also, a front turn part 51 that is a part of the first magnetic recording exciting coil 50 that is buried with the insulating layer 13 therebetween, is formed between the auxiliary magnetic pole layer 31 and auxiliary yoke layer 32 that configure the main pole direct junction magnetic layer 30. In other words, as illustrated in FIG. 6B and FIG. 7B, the first magnetic recording exciting coil 50 forms a successive one turn loop from a first rear end part 55 that is one end to a second rear end part 58 that is the other end as one embodiment, and includes the front turn part 51 intervened between the auxiliary pole layer 31 and the auxiliary yoke layer 32.

By directly joining the main pole layer 21 and the main pole direct junction magnetic layer 30 provided with the auxiliary pole layer 31 and the auxiliary yoke layer 32 in this manner, and also burying the front turn part 51 that is a part of the first magnetic recording exciting coil 50 with the insulating layer 13 therebetween, between the auxiliary pole layer 31 and the auxiliary yoke layer 32, the effective magnetic path length that is the total length of the magnetic path that is the actual path of the magnetic flux can be shortened.

In addition, the main pole direct junction magnetic layer 30 is so named for convenience when considering the integration of the auxiliary pole layer 31 and the auxiliary yoke layer 32. Generally, the auxiliary pole layer 31 and the auxiliary yoke layer 32 are often formed integrally and include the pillar layer 33 that is placed in the depth (X direction) of the auxiliary yoke layer 32.

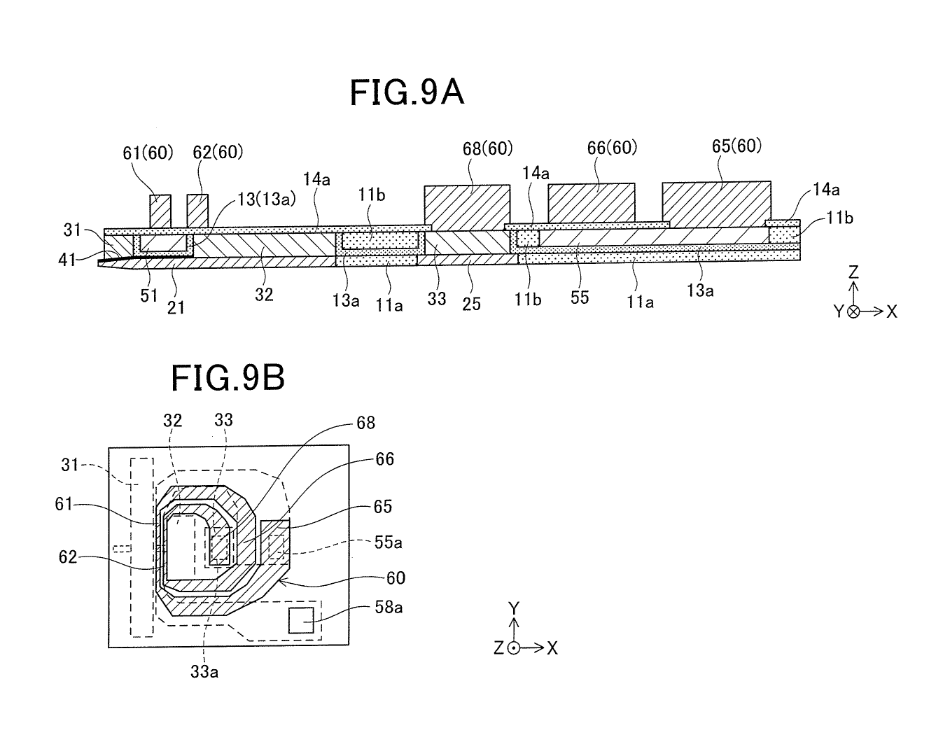

The second magnetic recording exciting coil is formed, with the insulating layer 14 therebetween, substantially on the first magnetic recording exciting coil 50 that is buried between the auxiliary pole layer 31 and the auxiliary yoke layer 3. In other words, as illustrated in FIG. 9B, the second magnetic recording exciting coil 60 forms a successive two turn loop from the first rear end part 65 that is one end to the second rear end part 68 that is the other end as one embodiment, thus forming a configuration having the front turn part 61 and the front turn part 62 respectively substantially on the front turn part 51 of the first magnetic recording exciting coil 50.

Also, by connecting the first rear end part 55 of the first magnetic recording exciting coil 50 and the first rear end part 65 of the second magnetic recording exciting coil 60, a magnetic recording exciting coil with a total of three turn loops can be formed. The magnetic recording exciting coil is preferably formed of a conductive material such as Cu (copper) or the like; however, it may of course be formed of other conductive materials.

The recording head in the present invention is preferably configured, as illustrated in FIG. 3A, so that t2 is larger than t1 when the thickness of the lamination direction of the first magnetic recording exciting coil 50 is t1 and the thickness of the lamination direction of the second magnetic recording exciting coil 60 is t2, and at the same time, the number of turns of the second magnetic recording exciting coil is greater than the number of turns of the first magnetic recording exciting coil. More specifically, it is preferred that t2=(2˜4)t1. The thickness t1 is 0.4 μm or above, and particularly, anywhere approximately between 0.4-1.0 μm.

The number of turns of the first magnetic recording exciting coil 50 is preferably within a range between 1-2, and the number of turns of the second magnetic recording exciting coil 60 is preferably within a range between 2-4.

Further, the second magnetic recording exciting coil 60 has a plurality of turns as described above, and it is preferred that an insulating layer of a dry film be buried in the wound coil gap. It is preferred that the insulating layer of dry film be configured from a material such as alumina or the like formed by the so-called atomic layer deposition method. In order to accurately fill and form the insulating layer of the dry film into the coil gap, a coil shape is particularly significant, and it is particularly preferred that the coil is not in an inverted taper shape in the depth direction.

Further, when the distance X1 from the front part of the first magnetic recording exciting coil 50 to the ABS 10 that is the medium opposing surface, and the distance X2 from the front part of the second magnetic recording exiting coil 60 to the ABS 10 that is the medium opposing surface, are compared, it is preferred that these magnetic recording exciting coils are arranged so as to be X2≠X1. More specifically, it is preferred that |X2−X1|=approx. 0-0.5 um (however 0 is not included).

By arranging in such manner, the expansion amount of the main pole due to heat generation of the coil 50 can be controlled, and as a result, the a protrusion amount of the main pole from the ABS can be controlled.

In addition, the second rear end part 68 that is the other end of the second magnetic recording exciting coil 60 is connected to the pillar layer 33.

A write shield layer 80 is formed on the front turn parts 61 and 62 of this type of second magnetic recording exciting coil 60 with the insulating layer 15 therebetween as illustrated in FIG. 3A. The write shield layer 80 is connected to the auxiliary pole layer 31 on the ABS 10 side as well as connected to the auxiliary yoke layer 32. A portion of the write shield layer 80 that is connected to the auxiliary yoke layer 32 functions as a linkage layer 81 to form a magnetic path.

Further, the write shield layer 80 forms a magnetic shield and a magnetic return part as well as forming a magnetic path by connecting to the auxiliary pole layer 31 on the ABS 10 side. In other words, the write shield layer 80 reaches the ABS 10 and functions as the magnetic guide path for the magnetic flux returned from the soft magnetic under layer that is provided under the magnetic recording layer (perpendicular magnetized layer) of the magnetic disc. The thickness of the write shield layer 80 is, for example, anywhere approximately between 0.5-5 μm. The auxiliary pole layer 31 linked to the write shield layer 80 on the ABS 10 side provides a function as a trailing shield to take in the recording magnetic flux that spreads out from the main pole layer 21.

The auxiliary pole layer 31 has a larger width in the track width direction than the main pole layer 21. By providing this type of auxiliary pole layer 31, the magnetic field gradient increases in steepness between the end part of the auxiliary pole layer 31 and main pole 21. As a result, the signal output jitter is diminished thereby enabling the error rate at the time of reading to be reduced. Further, although the write shield layer 80 is formed of a soft magnetic material, the auxiliary pole layer 31 is particularly preferred to be formed of NiFe (permalloy) or an iron-based alloy material similar to the main pole layer 21 or the like, having a high saturation magnetic flux density.

In contrast, a non-magnetic layer 90 is formed in an area that is rearward than the front turn parts 61 and 62 of the second magnetic recording exciting coil 60 with the insulating layer 12 (substantially similar to the insulting layer 15) therebetween as illustrated in FIG. 3A. This type of non-magnetic layer 90 is successively formed also on the write shield layer 80 and reaches to the ABS 10 that is the medium opposing surface. The non-magnetic layer 90 functions mainly as a passivation layer.

In addition, the magnetic path in the present invention is formed by the main pole layer 21, auxiliary yoke layer 32, write shield layer 80, and auxiliary pole layer 31, and the distance of a series of loops that actually pass through these magnetic paths is the effective magnetic path length. The present invention adopts a configuration where the main pole layer 21 and the main pole direct junction magnetic layer 30 provided with the auxiliary pole layer 31 and the auxiliary yoke layer 32 are directly joined in a state where the recording gap layer 41 is partially intervened near the ASB 10 in respect to the main pole layer 21 as described earlier, and moreover, it is further configured to that the front turn part 51 that is a part of the first magnetic recording exciting coil 50 buried with the insulating layer 13 therebetween, is formed between the auxiliary pole layer 31 and the auxiliary yoke layer 32, and therefore the magnetic path in the Z direction that is the lamination direction can be shortened thus making it possible for the effective magnetic path length to be shortened.

Shortening the effective magnetic path length can lead to a quick change to a recording signal with a high frequency and a rapid change. That is to say, the flux rise time of the magnetic head, the non-linear transition shift characteristics, and the over write characteristics and the like can be improved.

### Description of a Manufacturing Method of A Thin Film Magnetic Head

An essential part of the manufacturing method of the thin film magnetic head of the present invention is in a series of processes after the main pole layer is formed.

More specifically, the essential part of the manufacturing method of the thin film magnetic head of the present invention is configured by including a process to form an auxiliary pole layer and auxiliary yoke layer directly on a main pole layer in a state where the recording gap layer is partially intervened near the ABS after the main pole layer is formed, a first magnetic recording exciting coil forming process that includes a process to bury a part of the first magnetic recording exciting coil in the gap of the auxiliary pole layer and the auxiliary yoke layer with an insulating layer therebetween, and a second magnetic recording exciting coil forming process to form the second magnetic exciting coil while connecting to the first magnetic recording exciting coil.

A description will be given hereinafter of a preferred example of the manufacturing method of the present invention.

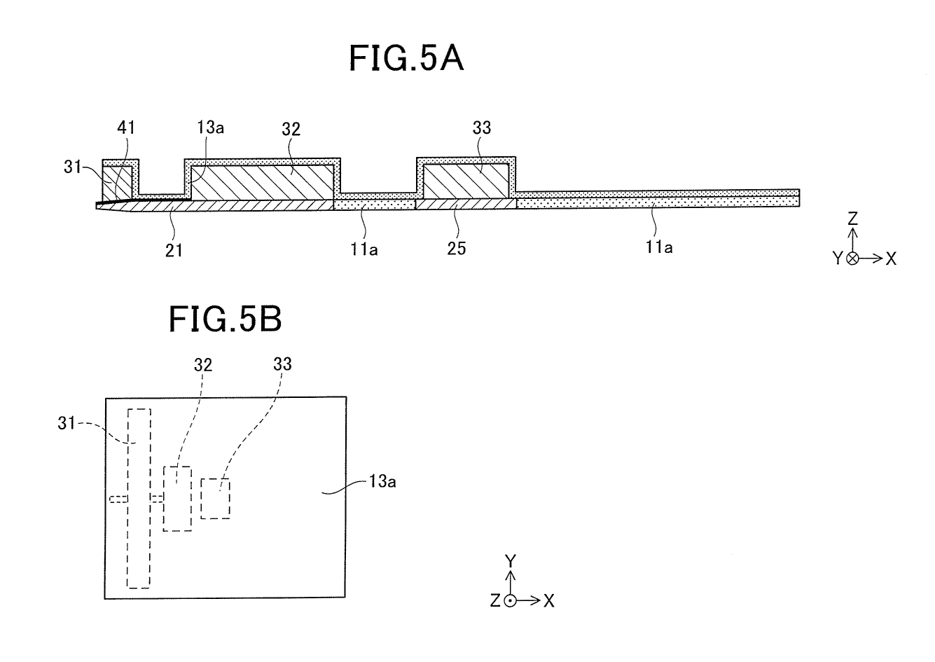

FIG. 4A is a cross-sectional view along the direction to intersect the ABS illustrating an example of a manufacturing process of the thin film magnetic head that relates to an example of a preferred embodiment of the present invention. FIG. 4B is a plan view of FIG. 4A. In addition, the reduction in scale of both drawings is not depicted correspondently due to space restrictions on the surface of the paper, and FIG. 4B is in an exceedingly-reduced state. The relationships of the following drawings FIG. 5A to FIG. 13A and FIG. 5B to FIG. 13B that respectively correspond thereto are the same respectively.

As illustrated in FIG. 4A and FIG. 4B, after forming the main pole layer 21, the auxiliary pole layer 31 and the auxiliary yoke layer 32 are formed directly on the main pole layer 21 leaving a prescribed gap G1 in a state where the recording gap 41 is partially intervened near the ABS of the medium opposing surface. Further, the pillar layer 33 is provided in the rearward (X direction) of the auxiliary yoke layer 32.

In addition, as illustrated in FIG. 4A, a rear part magnetic layer 25 is formed in the rearward (X direction) of the main pole layer 21, and an insulating layer 11a is formed rearward of the rear part magnetic layer 25 between the main pole layer 21 and the rear part magnetic layer 25. The main pole layer 21 and the rear part magnetic layer 25 may be configured from the same magnetic material. The recording gap layer 41 that is formed on the main pole layer 21 can be formed by laminating substantially the entire area on the main pole layer 21 then removing the excess by a milling process to leave only that from the tip end of the main pole layer 21 to the front part 32a of the auxiliary yoke layer 32.

In the illustrated embodiment, the gap G1 between the auxiliary pole layer 31 and the auxiliary yoke layer 32 is, for example, approximately 2.0 μm.

In order to form the auxiliary pole layer 31, auxiliary yoke layer 32, and pillar layer 33, for example, an integrated magnetic layer that includes these is formed, for example, a plating method on an integrated layer that includes the gap layer 41, main pole layer 21, insulating layer 11a, and the like, and afterwards, a resist with a prescribed patterned is prepared using a photoresist technique to utilize the patterned resist as a mask, and then, the exposed integrated magnetic layer is etched. Or, it can also be achieved by preparing a resist with a prescribed asperity pattern using a photoresist technique on an integrated film that includes the recording gap layer 41, main pole layer 21, insulating layer 11a and the like so as to fill the auxiliary pole layer 31, auxiliary yoke layer 32, and pillar layer 33 in a resist concave part.

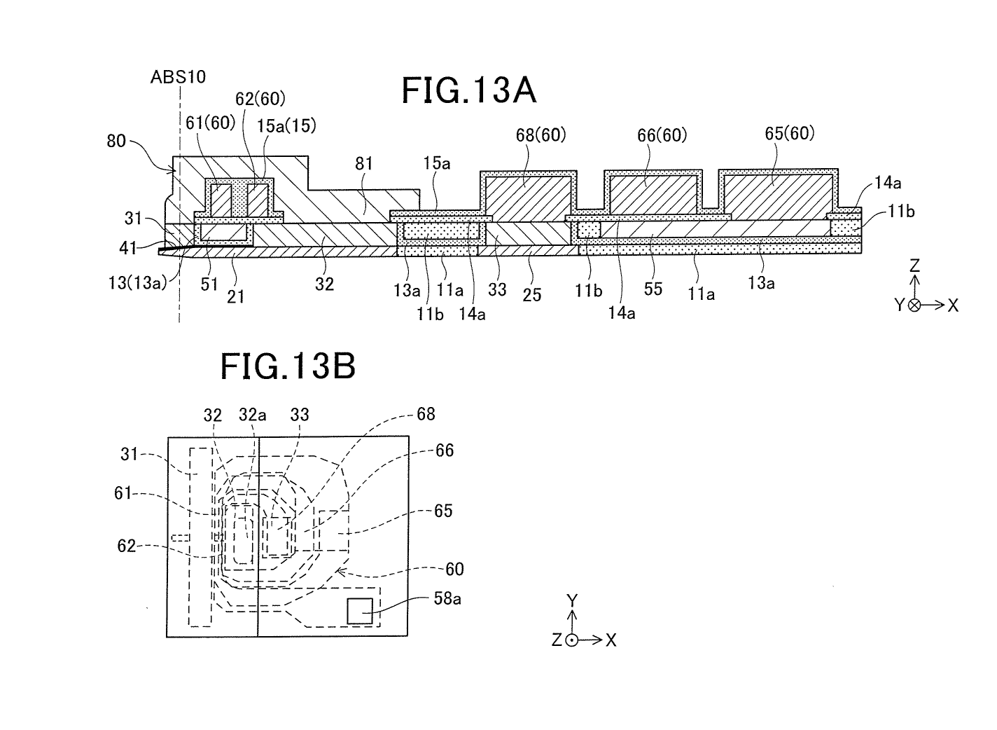

In addition, it should be noted that the ABS 10 is ultimately formed on the head end surface side of the left side in the drawing as illustrated in FIG. 4A and FIG. 4B, by polishing the end surface in the X direction from the left end of the drawing to the position where the ABS 10 is written so as to obtain a prescribed height after a desired head lamination film is formed (for example, after a passivation layer that is the non-magnetic layer 90 is laminated and formed (refer to FIG. 3A) adding to the configuration illustrated in FIG. 13). Please also take similar note of the drawings in FIG. 4 to FIG. 13 although the ABS is not specified.

Subsequently, an insulating layer 13a made of, for example, alumina is formed on the entire area illustrated in the drawings, as illustrated in FIG. 5A and FIG. 5B, using a film formation method, for example, an atomic layer deposition method or the like.

Next, a first magnetic recording exciting coil 50 with one turn is formed by a plating method or the like as illustrated in FIG. 6A and FIG. 6B. For example, an electroless plated film may be formed as a seed film to form plated film using the seed film. In addition, a coil shape can be depicted, for example, by using a prescribed coil shape pattern formed by use of a photoresist technique. By doing so, the front turn part 51 that is a part of the first magnetic recording exciting coil 50 is buried between the auxiliary pole layer 31 and the auxiliary yoke layer 32 with the insulating layer 13 (13a) therebetween.

Next, a surface planarization process is performed by chemical mechanical polishing (CMP) after an insulating film 11b made of, for example, alumina or the like is deposited on the entire area illustrated in the drawings as illustrated in FIG. 7A and FIG. 7B. Accordingly, the thickness t1 of the lamination direction of the first magnetic recording exciting coil 50, the thicknesses in the lamination direction of the auxiliary pole layer 31 and the auxiliary yoke layer 32 are determined.

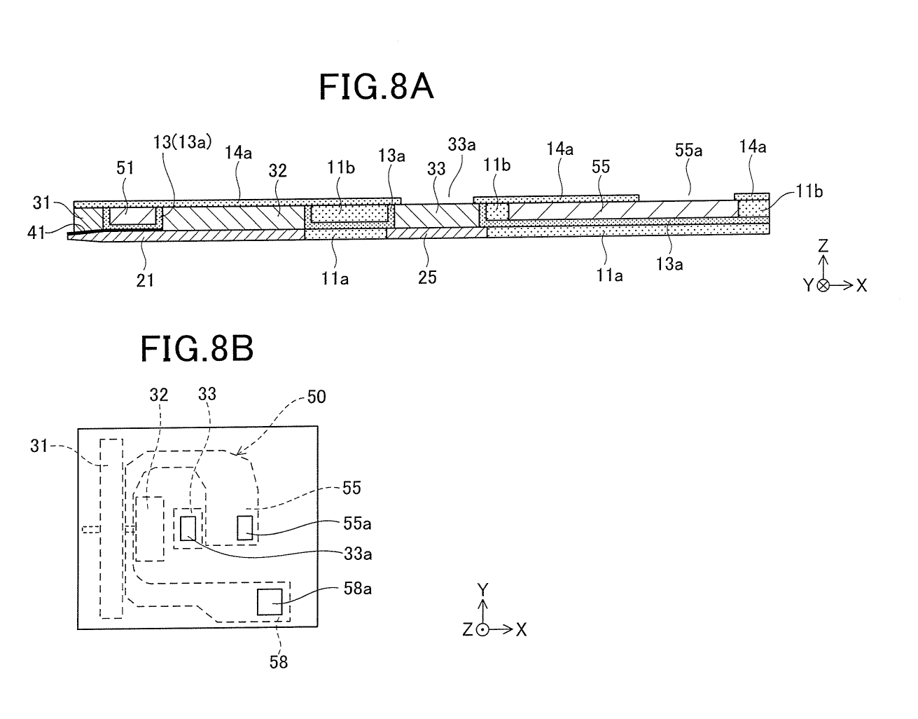

Next, as illustrated in FIG. 8A and FIG. 8B, contact parts 55a, 58a, and 33a are respectively formed as in the illustrations by exposing a part of the first rear end part 55 and the second rear end part 58 of the first magnetic recording exciting coil 50 and a part of the pillar layer 33 (by partially peeling off the corresponding insulating film 14a) after an insulating layer 14a made of, for example, alumina or the like, is deposited on the entire area illustrated in the drawings. In addition, in order to respectively form the contact parts 55a, 58a, and 33a as in the illustrations, a prescribed resist pattern may be prepared by, for example, a photoresist technique, and thereafter, the corresponded insulating film 14a may be partially peeled off by etching or the like.

Next, a second magnetic recording exciting coil 60 is formed by a plating method or the like as illustrated in FIG. 9A and FIG. 9B. For example, an electroless plated film may be formed as a seed film to form plated film using the seed film. The coil shape can be depicted, as described above, by using a prescribed coil shape pattern formed by use of a photoresist technique.

As illustrated in FIG. 9B, the second magnetic recording exciting coil 60 forms successive two turn loops from the first rear end part 65 that is one end to the second rear end part 68 that is the other end as the one embodiment, and includes the front turn part 61 and the front turn part 62 in substantially on the front turn part 51 of the first magnetic recording exciting coil 50. Also, by connecting the contact part 55a of the first rear end part 55 of the first magnetic recording exciting coil 50 and the rear end part 65 of the second magnetic recording exciting coil 60, the magnetic recording exciting coil with a total of three turn loops can be formed. In addition, the second rear end part 68 that is the other end of the second magnetic recording exciting coil 60 is connected to the contact part 33a of the pillar layer 33.

Also, the pillar layer 33 and the contact part 55a of the second rear end part 58 of the first magnetic recording exciting coil 50 are respectively connected to a wire, not illustrated, so that a current can be applied to a series of connected first and second magnetic recording exciting coils.

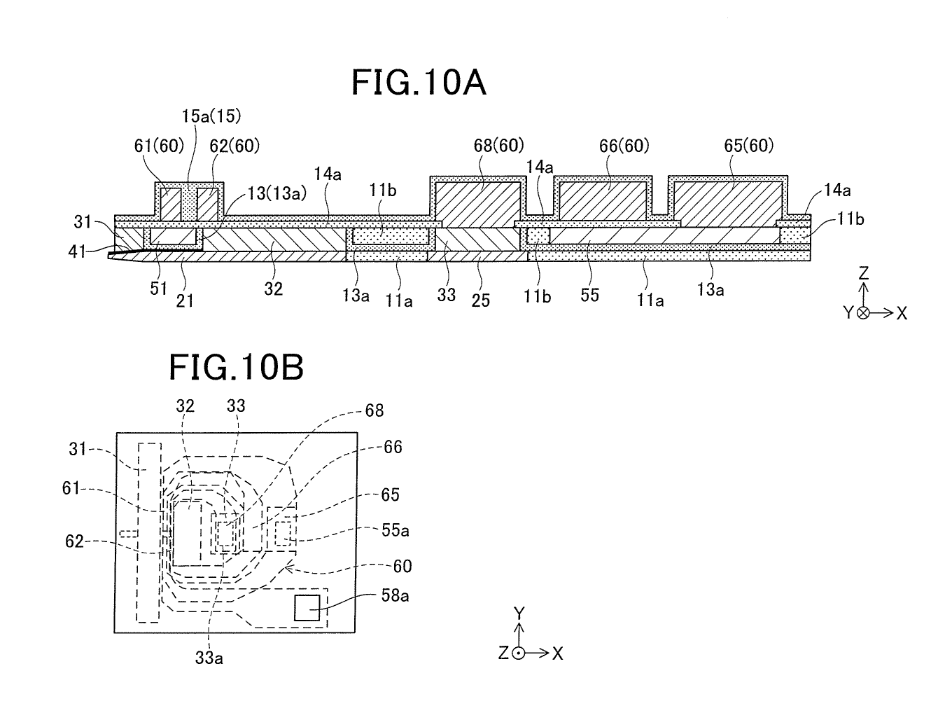

Next, as illustrated in FIG. 10A and FIG. 10B, an insulating layer 15a made of alumina is formed on the entire area illustrated in the drawings as a preferred example of the insulating layer of the dry film, by using a film formation method, for example, the atomic layer deposition method or the like. By so doing, the insulating layer of the dry film is buried in the gap of the wound coil, and particularly in the gap between the front turn part 61 and the front turn part 62. Because the insulating layer of the dry film has a small thermal expansion coefficient that is substantially similar to the periphery material, the protruding part generated by the partial push out on the ABS end part that is the medium opposing surface is less likely to occur. As described above, in order to accurately fill and form the insulating layer of the dry film into the coil gap, it is preferred to take note that the coil shape is particularly not to be in an inverse taper shape.

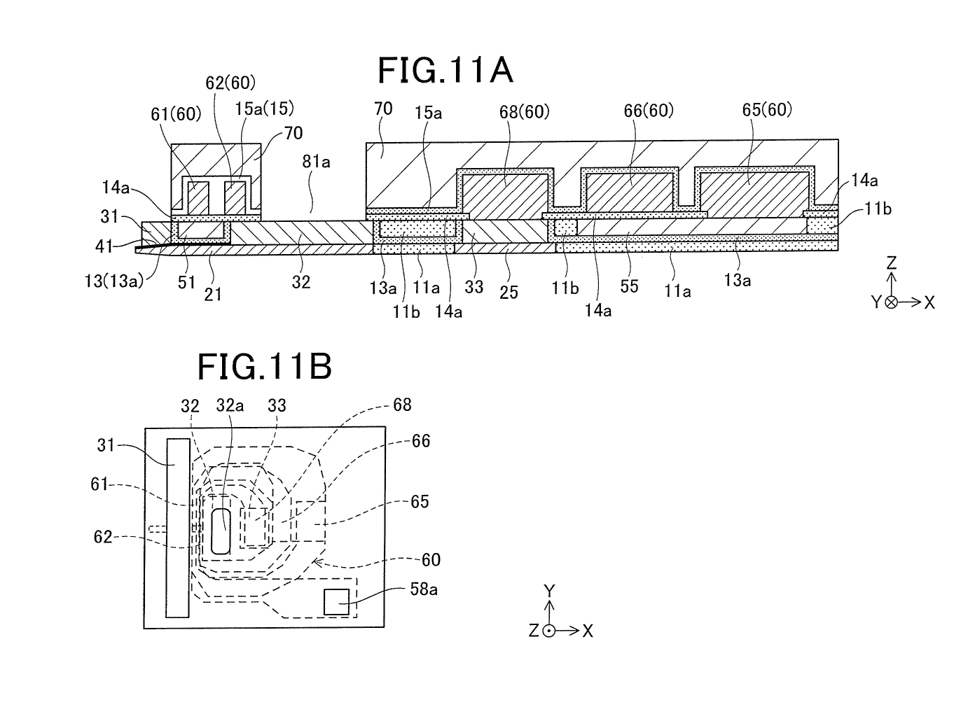

Next, as illustrated in FIG. 11A and FIG. 11B, a pattern of a prescribed resist 70 is prepared by a photoresist technique, and thereafter, a link opening 81a is formed in order to link the auxiliary yoke layer 32 by etching.

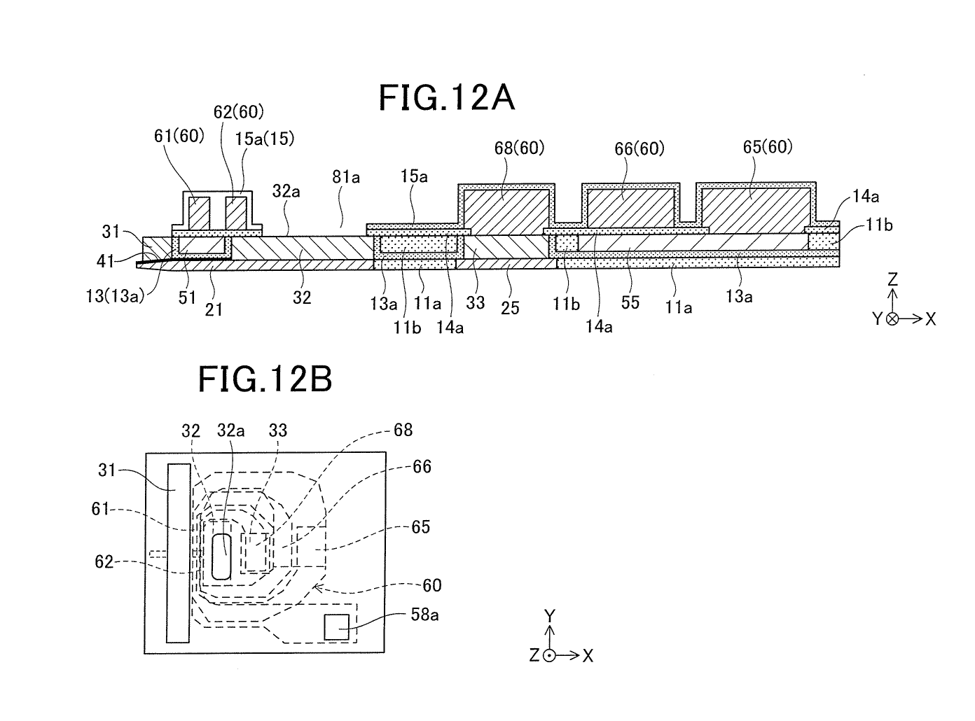

Next, as illustrated in FIG. 12A and FIG. 12B, the resist 70 (refer to FIG. 11A) is removed, and a contact part 32a is formed by exposing the upper surface of the auxiliary yoke layer 32 in conjunction with the formation of the link opening 81a.

Next, as illustrated in FIG. 13A and FIG. 13B, a write shield layer 80 is formed. In order to form the write shield layer 80 in the prescribed portion, a prescribed resist pattern is prepared by a photoresist technique, and after forming the write shield layer 80, the resist is removed. The write shield layer 80 is connected to the auxiliary yoke layer 32, and connected to the auxiliary pole layer 31 on the ABS 10 side as illustrated in FIG. 13A. The area connecting to the auxiliary yoke layer 32 functions as a linkage layer 81 to form a magnetic path.

Next, after the passivation layer 90 is laminated and formed (refer to FIG. 3A) further on the laminated configuration illustrated in FIG. 13A, the end surface is polished in the X direction from the left end of the drawing to the position where the ABS 10 is written so as to obtain a prescribed height and ultimately to form the ABS 10.

As described above, because the thin film magnetic head of the present invention is configured so as to provide the main pole layer, and the main pole direct junction magnetic layer provided with the auxiliary pole layer and the auxiliary yoke layer that are directly joined in a state where a recording gap layer is partially intervened near the ABS with respect to the main pole layer, and the first magnetic recording exciting coil that is buried between the auxiliary pole layer and the auxiliary yoke layer with an insulating layer therebetween, the effective magnetic path length can be shortened in order to improve the high-frequency characteristics, and furthermore, simplification of the manufacturing processes becomes possible.

What is claimed is:

1. A thin film magnetic head comprising:
a main pole layer;
a main pole direct junction magnetic layer that has an auxiliary pole layer and an auxiliary yoke layer, the main pole direct junction magnetic layer being directly joined to the main pole layer in a state where a recording gap layer is partially intervened near an air bearing surface (ABS) with respect to the main pole layer; and
a first magnetic recording exciting coil that is buried between the auxiliary pole layer and the auxiliary yoke layer configuring the main magnetic direct junction magnetic layer with an insulating layer therebetween.

2. The thin film magnetic head according to claim 1, wherein
a second magnetic recording exciting coil is formed on the first magnetic recording exciting coil with an insulating layer therebetween.

3. The thin film magnetic head according to claim 1, wherein
t2 is larger than t1 where the t1 is the thickness of the lamination direction of the first magnetic recording exciting coil and the t2 is the thickness of the lamination direction of the second magnetic recording exciting coil, and
at the same time, a number of turns of the second magnetic recording exciting coil is larger than a number of turns of the first magnetic recording exciting coil.

4. The thin film magnetic head according to claim 2, wherein
the second magnetic recording exciting coil has a plurality of turns and an insulating layer, which is a dry film, is buried in a wound coil gap.

5. The thin film magnetic head according to claim 4, wherein
the insulating layer of the dry film is an alumina film that is formed by an atomic layer deposition method with an insulating material.

6. The thin film magnetic head according to claim 2, wherein
X2≠X1 when the X2 and X1 are compared,
where X1 is defined as a distance from the front part of the first magnetic recording exciting coil to the ABS and X2 is defined as a distance from the front part of the second magnetic recording exciting coil to the ABS.

7. A head gimbal assembly comprising:
a slider that includes the thin film magnetic head according to claim 1, the slider being arranged so as to oppose a magnetic recording medium; and
a suspension to elastically support the slider.

8. A magnetic recording device comprising:
a slider that includes the thin film magnetic head according to claim 1, the slider being arranged so as to oppose a magnetic recording medium; and
a positioning device that positions the slider with respect to the magnetic recording medium as well as supports the slider.

9. A manufacturing method of the thin film magnetic head according to claim 1 comprising:
a process to form the auxiliary pole layer and the auxiliary yoke layer directly on the main pole layer in a state where the recording gap layer is partially intervened near the air bearing surface (ABS) after forming the main pole layer;
a first magnetic recording exciting coil forming process that includes a process to bury a part of the first magnetic recording exciting coil in a gap of the auxiliary pole layer and the auxiliary yoke layer with the insulating layer therebetween; and
a second magnetic recording exciting coil forming process to form a second magnetic recording exciting coil while connecting to the first magnetic recording exciting coil.

10. The manufacturing method of the thin film magnetic head according to claim 9 comprising:
an insulating layer forming process to enhance insulation with respect to the second magnetic recording exciting coil;
an exposure process of the auxiliary pole layer and the auxiliary yoke layer to form a contact part by exposing the auxiliary pole layer and the auxiliary yoke layer; and
a write shield layer forming process to form a write shield layer on the exposed auxiliary pole layer and the auxiliary yoke layer.
